(19) United States
(12) Patent Application Publication
(10) Pub. No.: US 2016/0131789 A1
(43) Pub. Date: May 12, 2016

(54) DEVICE AND METHOD FOR DETECTING UNEXPLODED ORDINANCE IN MINERALIZED SOIL

(71) Applicant: Geonics Limited, Ontario (CA)

(72) Inventor: Miroslav Bosnar, Ontario (CA)

(21) Appl. No.: 14/939,103

(22) Filed: Nov. 12, 2015

Related U.S. Application Data
(60) Provisional application No. 62/078,943, filed on Nov. 12, 2014.

(51) Int. Cl. G01V 3/10; G01S 19/14

(52) U.S. Cl. CPC G01V 3/10; G01S 19/14

(57) ABSTRACT

A detector for detecting target devices in magnetic soil, comprising: a transmitter; a sensor; and a processing system for driving the transmitter to generate periodic pulses, and processing a secondary response measured by the sensor at two different time positions after termination of the transmitter pulse to filter out a secondary response caused by the soil.

### RELATED APPLICATIONS

This application claims the benefit of and priority to U.S. Patent Application No. 62/078,943, filed Nov. 12, 2014, the contents of which are incorporated by reference.

### BACKGROUND

The present disclosure relates to devices and methods for detecting anomalous objects, and more particularly to devices and method for detecting Unexploded Ordinance (UXO) in mineralized soil.

Detection of UXO devices is a global concern. Many years after conflict in a region has ended, UXO devices remain and pose dangerous hazards to people who live in and visit the region. By way of example, air dropped cluster bombs that distribute bomblets have been frequently used in conflicts throughout the world during the last half century and the resulting bomblets remain dispersed over wide areas. A common example of a widely dispersed UXO is the BLU series of submunitions, including for example the BLU-26 and BLU-36 submunitions, which are small aerial dispensed, centrifugal armed, high-explosive fragmentation bomblets that have an aluminum body embedded with steel fragmentation balls. The tennis-ball sized (about 2.5″ diameter) BLU-26 bomblets were originally configured to either explode on impact with the ground, to air burst above ground, or to explode with fixed-period delayed detonation. Upon explosion, BLU-26 disperses hundreds of steel balls in many directions. There are millions of such bomblets, many unexploded, all around the world and specifically a very large proportion in South East Asia from the Vietnam war, killing innocent civilians every day.

Electromagnetic (EM) based detectors that use a transmitter to direct a primary EM signal at a target ground region and one or more receiver coils to measure the secondary response from the ground are commonly used to locate UXO devices. However, the detection of small UXO devices in soil that is relative magnetic conductive, such as mineralized soil, can prove troublesome.

### SUMMARY

According to an example embodiment is a detector for detecting target devices in magnetic soil, comprising: a transmitter; a sensor; and a processing system for driving the transmitter to generate periodic pulses, and processing a secondary response measured by the sensor at two different time positions after termination of the transmitter pulse to filter out a secondary response caused by the soil.

According to an example embodiment is a detector for detecting an unexploded ordinance (UXO) device in magnetic soil, comprising: a transmitter loop, a receiver coil, and a signal driver and processing system for driving the transmitter loop to generate periodic pulses, and processing secondary responses measured through the receiver coil at two time positions after termination of a transmitter pulse to filter out a secondary response caused by the magnetic soil.

According to an example embodiment is a method for detecting an a UXO device in ground, comprising: transmitting an electromagnetic (EM) pulse towards the ground; measuring at a first time position and a later second time position responses of the ground to the electromagnetic pulse; combining the responses measured at the first time position and the second time position to filter signals resulting from magnetic soil conditions; and determining the location of a possible UXO device in dependence on the combined responses.

According to an example embodiment is an apparatus for detecting target objects in a ground surface, comprising: a platform supporting an electromagnetic (EM) transmitter and at least one sensor; and a signal driver and processing system connected to drive the EM transmitter to generate an EM pulse towards the ground surface and to measure, through the sensor, a first response of the ground surface at a first time position after the EM pulse and a second response of the ground surface at a later second time position after the EM pulse. The signal driver and processing system combines the first response and the second response to filter out the effects of magnetic soil in the ground surface and provide an output that indicates possible presence of target objects.

### FIGURES

FIG. 1 is a schematic illustration of a UXO detector according to an example embodiment.

FIGS. 2A and 3A show examples of raw data obtained by receiver coils of the UXO detector of FIG. 1 and FIGS. 2B and 3B each show a final processed result.

FIG. 4 illustrates an example of a response measured by receiver coils of the UXO detector of FIG. 1 showing ground response G(t) and a BLU-26 target response T(t).

### DESCRIPTION

Example embodiments are directed to a UXO detector for detecting UXO devices such as bomblets or submunitions located in a relatively magnetic environment such as in highly mineralized soil. One example of a UXO device that the described equipment can be used to detect is the BLU-26 submunition, however the described equipment can also be used for the detection of other submunitions that have similar characteristics to BLU-26.

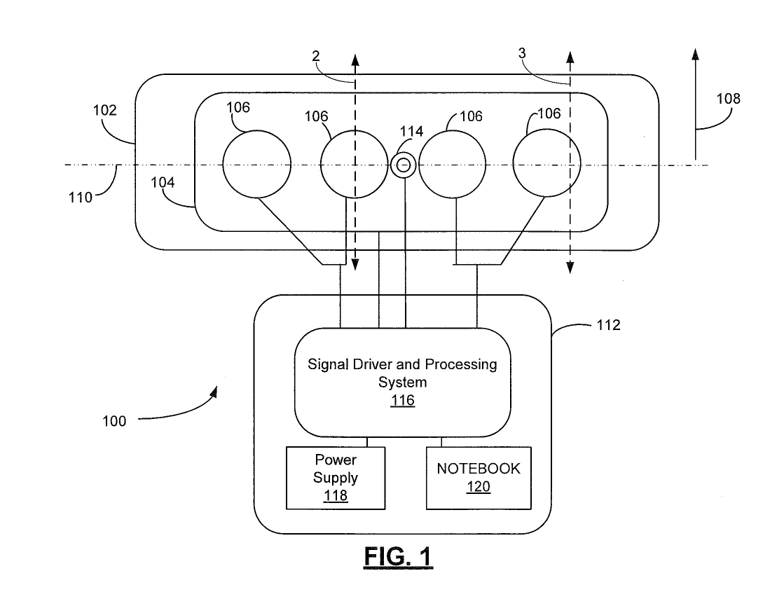

In this regard, FIG. 1 illustrates an example of a UXO detector 100 according to example embodiments, which is a time-domain EM device. UXO detector 100 includes a sensor platform 102 that supports a multi-turn transmitter loop 104 and four horizontally spaced receiver coils 106. The multi-turn transmitter loop 104 and four horizontally spaced receiver coils 106 are arranged so that during use they will be oriented in a common horizontal plane generally parallel to the ground surface with a vertical dipole axis. Transmitter loop 104 encircles the receiver coils 106, which are spaced apart from each other and arranged along a common horizontal centerline or axis 110 that is perpendicular to an intended direction of travel 108. In an example embodiment, sensor platform 102 is configured to be mounted to a ground based motor vehicle, however the platform could also be configured to be mounted on a cart or to be carried by a person. In the illustrated example four receiver coils 106 are used to increase survey swath (width of survey) but other numbers of receiver coils can be used as well, including as few as one.

In an example embodiment the UXO detector 100 includes console platform 112 that houses a signal driver and processing system 116 that includes a signal generator to drive the transmitter loop 104, and acquisition, processing and display hardware to acquire and process signals received from the receiver coils 106. Console platform 112 can also support a portable power supply 118 to power system 116. The signal generator is a current pulse generator that drives transmitter loop 104 to induce current in soil and targets. The transmitter loop produces a periodic pulse signal that has an “on” duration to provide a primary EM field, followed by an “off” duration. The resulting secondary currents generate a secondary field measured by the four receiver coils 106 during the “off” duration. In an example embodiment, the signals from the receiver coils are digitized and time and location stamped (based for example, on time and location signals received from GPS receiver 114), and then processed by digital processing equipment that is part of signal driver and processing system 116. The processing system 116 is configured to remove the masking response of magnetically susceptible soil that can be many orders of magnitude larger than response from target of interest, namely a UXO device such as a BLU-26 submunition.

Accordingly, the UXO detector 100 enables a user (interpreter) to filter out the response from the magnetic soil and remove its masking effect. The filter is based on the distinctive different time decay between magnetic ground response and the target. In this regard, during operation, each receiver coil 106 measures a secondary response at two specific time positions, early and late time, after termination of the transmitter pulse.

The data processing and removal of soil response is based on a different time behaviour (decay rate) between soil and target response. In particular, in the case of a submunition such as BLU 26, it was found that at two specific time positions the response at the early time channel is 2.7 times larger than at the late time for magnetic soil while from BLU 26 target this ratio is about 5 times.

Accordingly, in an example embodiment, the processing equipment on console platform 112 is configured to implement the following processing:

V_{R}=V_{E}−KₜV_{L}

where
V_{R} is final filtered output
V_{E} is early time measurement
V_{L} is late time measurement.

### Kₜ is 2.7.

Such processing removes soil response from final results while clean signal, reduced by about 50%, is displayed and digitally recorded. In an example embodiment, a notebook computer 120 provided as part of console 112 functions as a data recording and display device for displaying information back to a system operator.

The filtering technique described above, including the constant Kₜ=2.7, is specifically designed to remove a masking effect arousing from magnetically susceptible soil from response of a BLU 26 submunition, but a similar filtering technique can be equally applied to the different types of target as long as there is noticeable difference in time delay behaviour response between target and soil. Thus, the value of the constant Kₜ can be affected by the composition of the target object and the soil that the object is located in. Additionally, the value of the constant can be impacted by the timing of, duration of and the delay between the first and second time positions at which response measurements are acquired. In some example embodiments, the constant Kₜ could be within the range of 2.5 to 3, however other values may be suitable in some applications. In some embodiments, the value of Kₜ is user configurable. In view of the safety issues involved, in at least some example embodiments user authentication is required such that only an authorized person can adjust selected operating parameters of the UXO detector such as the value of Kₜ.

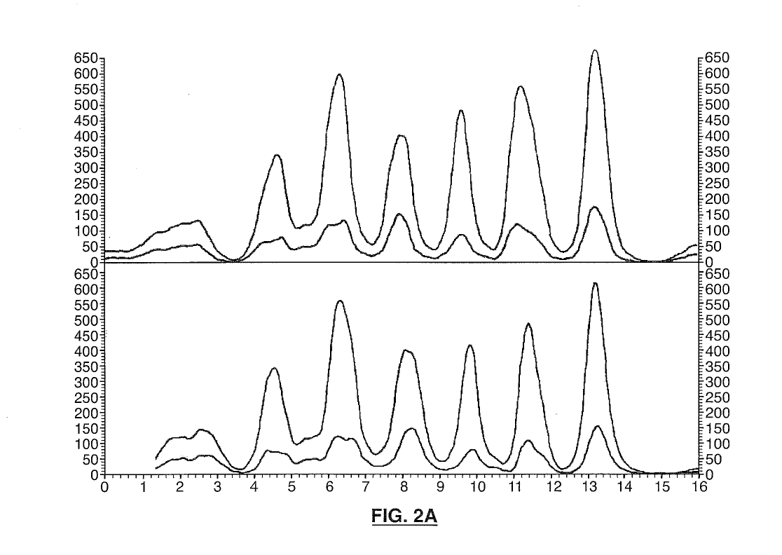

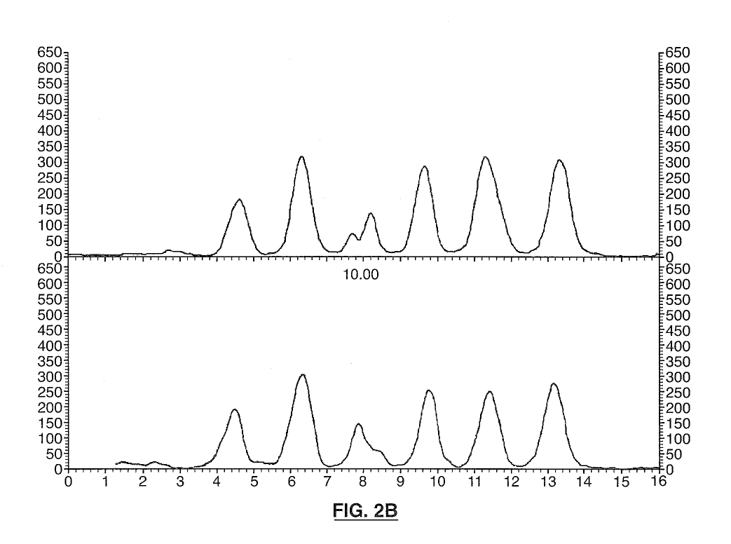

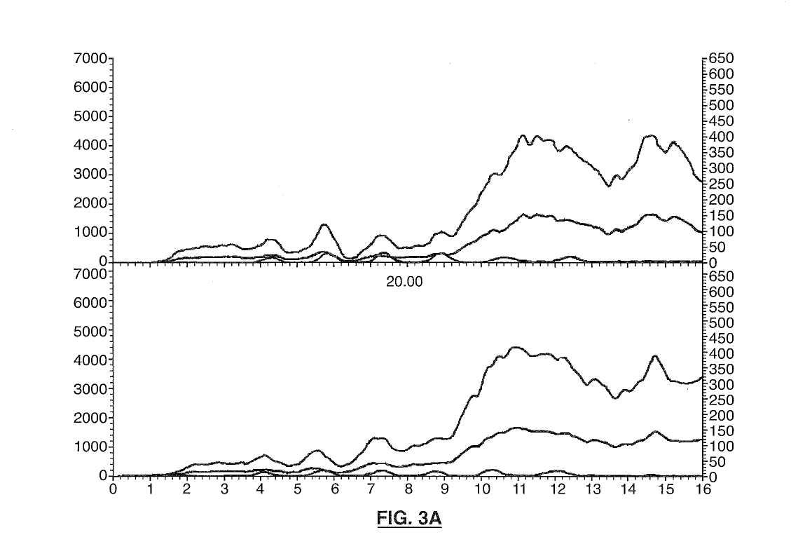

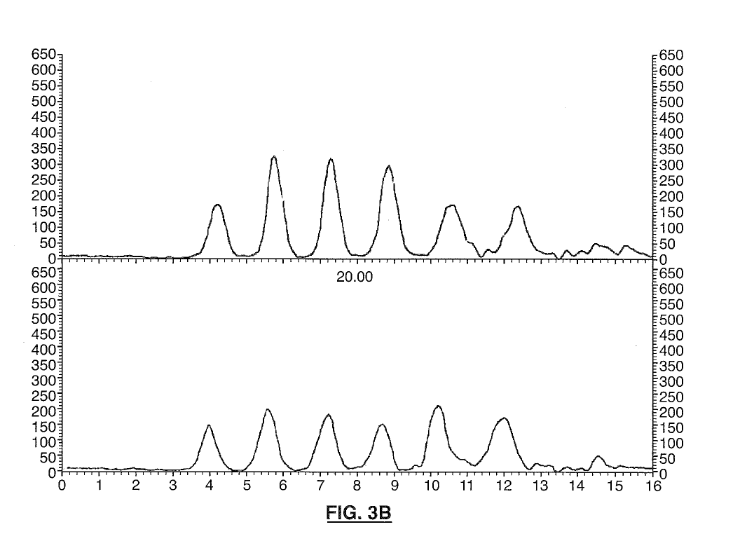

FIGS. 2A, and 3A show examples of raw data obtained by receiver coils 106 and FIGS. 2B and 3B each show a final processed result output by console platform 112. In this regard, FIGS. 2A and 3A are two examples of raw data that includes the total combined response of soil and six BLU 26 devices imbedded in the soil at different depths from 10 cm to 35 cm below surface. In the example of FIG. 2A, the BLU 26 devices are located generally at the location indicated by arrow 2 in FIG. 1 relative to the sensor platform 102, and in the example of FIG. 3A, the BLU 26 devices are located generally at the location indicated by arrow 3 in FIG. 1. FIGS. 2B and 3B show the respective results after applying the background removal filter.

In an example embodiment, transmitter coil 104 is approximately 0.67 m by 2.73 m, with 19 turns, however numerous configurations are possible.

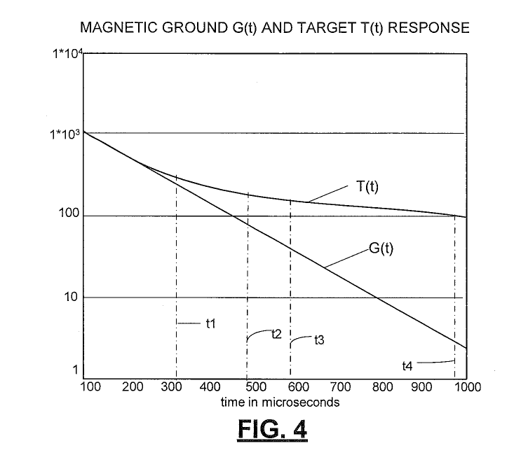

In order to facilitate a better understanding, FIG. 4 illustrates an example of a response measured by receiver coils 106 representing the ground response G(t) for magnetically susceptible soil and a BLU 26 target response T(t).

In the example of FIG. 4:

$$T ( t ) := 2000 \cdot {e}^{- ( \frac{t}{τ} )} \\ target response with time , where τ := 151 ( μs ) \\ G ( t ) := 100000. {t}^{- 1.0} \\ magnetically susceptible soil response with time \qquad magnetically susceptible soil response with time$$

In the example of Figure the early time position is from t1 to t2, and the late time position is from t3 to t4. In particular, the response is integrated (measured) between t1 and t2 and between t3 and t4 as follows:

$$\begin{matrix}E g := {\int }_{t 1}^{t 2} G ( t ) d t \cdot k L g := \frac{{\int }_{t 3}^{t 4} G ( t ) d t}{N} \\ outputs from early and late gate for ground response \\ E t := {\int }_{t 1}^{t 2} T ( t ) d t \cdot k L t := \frac{{\int }_{t 3}^{t 4} T ( t ) d t}{N} \\ outputs from early and late gate for target response\end{matrix}$$

Where, in the illustrated example:

$$t 1 := 320 μ s t 2 := 470 ( μ s )$$

$$early gate period of integration ( measurements )$$

$$t 3 := 570 μ s t 4 := 970 μ s$$

$$late gate period of integration ( measurements )$$

$$k := \frac{G e}{G l}$$

$$where Ge is early channel gain and Gl is late channel gain , \\ and k is channel gain normalization factor k = 1.5$$

$$N := \frac{( t 4 - t 3 )}{( t 2 - t 1 )}$$

$$where N is gates width difference normalization$$

$$factor N = 2.667$$

$$E g = 5.766 \cdot {10}^{4} Lg = 1.994 \cdot {10}^{4}$$

$$early and late gate outputs for ground$$

$$\frac{E g}{L g} = 2.892 filter factor$$

$$E t = 3.427 \cdot {10}^{4} L t = 2.414 \cdot {10}^{3}$$

$$outputs from early and late gate for target$$

$$D g t := ( Eg + Et ) - ( Lg + Lt ) \cdot \frac{Eg}{Lg} Dg t = 2.728 \cdot {10}^{4}$$

$$output with applied filter$$

$$D t := ( 0 + Et ) - ( 0 + Lt ) \cdot \frac{Eg}{Lg} D t = 2.728 \cdot {10}^{4}$$

$$target response$$

$$D g := ( Eg + 0 ) - ( Lg + 0 ) \cdot \frac{Eg}{Lg} D g = 0$$

$$ground response$$

$$\frac{Dt}{Et} = 0.796$$

$$reduction of target response due to application$$

$$of filter for early gate$$

It will thus be appreciated how responses measured at an early time and a late time following the EM pulse can be combined to filter out the magnetic soil response and provide an increased sensitivity for detection of UXO devices such as BLU-26 and similar devices. In the example of FIG. 4, the early time position comprises a shorter integration duration (470 μs−320 μs=150 μs) than the later time position (970 μs−570 μs=400 μs)—less than half the duration. The integration durations used for the respective time positions could be different from the specific example in some applications. In the illustrated embodiments, both the early and late positions occur within 1000 μs of the start of the “off” pulse.

In example embodiments, the operating parameters of signal driver and processing system 116 can vary from those set out above in dependence on the actual device configuration, operating environment, soil conditions and target object properties. For example, in addition to the constant noted above, the duration of the early and late time positions during which measurements are acquired, the post-pulse timing of the time positions, and the delay between the positions, all may vary from the example values set out above. In some embodiments, these parameters are variable and configurable by a user or authorized party.

The present disclosure provides certain example algorithms and calculations for implementing examples of the disclosed methods and systems. However, the present disclosure is not bound by any particular algorithm or calculation.

Although the present disclosure describes methods and processes with steps in a certain order, one or more steps of the methods and processes may be omitted or altered as appropriate. One or more steps may take place in an order other than that in which they are described, as appropriate.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, aspects of the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, while the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. The subject matter described herein intends to cover and embrace all suitable changes in technology.

1. A detector for detecting an unexploded ordinance (UXO) device in magnetic soil, comprising:
a transmitter loop;
a receiver coil; and
a signal driver and processing system for driving the transmitter loop to generate periodic pulses, and processing secondary responses measured through the receiver coil at two time positions after termination of a transmitter pulse to filter out a secondary response caused by the magnetic soil.

2. The detector of claim 1 wherein the two time positions include an early time position and a later time position, the signal driver and processing system being configured to filter out the secondary response caused by the magnetic soil by subtracting a product of the secondary response measurement of the later time position and a predetermined constant from the secondary response measurement of the early time measurement, the predetermined constant being selected in dependence on a difference in a time decay between a response of the magnetic soil and a response of the UXO device.

3. The detector of claim 2 wherein the early time position includes an early time period over which a measurement is integrated and the later time position includes a later time period over which a measurement is integrated.

4. The detector of claim 3 wherein the early time period is shorter than the later time period.

5. The detector of claim 4 wherein the early time period is less than ½ of that of the later time period.

6. The detector of claim 1 comprising a plurality of receiver coils arranged along a common horizontal centerline relative to an intended direction of travel.

7. The detector of claim 4 wherein the receiver coils are within a perimeter defined by the transmitter coil.

8. The detector of claim 1 comprising a GPS receiver for associating time and location signals with the measured secondary responses.

9. A method for detecting an a UXO device in ground, comprising:
transmitting an electromagnetic (EM) pulse towards the ground;
measuring at a first time position and a later second time position responses of the ground to the electromagnetic pulse;
combining the responses measured at the first time position and the second time position to filter signals resulting from magnetic soil conditions; and
determining the location of a possible UXO device in dependence on the combined responses.

10. The method of claim 9 wherein combing the responses comprises subtracting a product of the response measured at the second time position and a predetermined constant from the response measured at the first time position, the predetermined constant being selected in dependence on a difference in a time decay between a response of magnetic soil and a response of a target UXO device.

11. The method of claim 10 wherein the first time position includes an early time period over which a measurement is integrated and the second time position includes a later time period over which a measurement is integrated.

12. The method of claim 11 wherein the early time period is shorter than the later time period.

13. The method of claim 11 wherein the early time period is less than ½ of that of the later time period.

14. The method of claim 11 comprising associating time and location signals from a GPS receiver with the measured responses.

15. An apparatus for detecting target objects in a ground surface, comprising:
a platform supporting an electromagnetic (EM) transmitter and at least one sensor;
a signal driver and processing system connected to drive the EM transmitter to generate an EM pulse towards the ground surface and to measure, through the sensor, a first response of the ground surface at a first time position after the EM pulse and a second response of the ground surface at a later second time position after the EM pulse, the signal driver and processing system combining the first response and the second response to filter out the effects of magnetic soil in the ground surface and provide an output that indicates possible presence of target objects.

16. The apparatus of claim 15 wherein combing the responses comprises subtracting a product of the second response and a predetermined constant from the first response, the predetermined constant being selected in dependence on a difference in a time decay between a response of magnetic soil and a response of a target object.

17. The apparatus of claim 16 wherein the first time position includes an early time period over which a measurement is integrated and the second time position includes a later time period over which a measurement is integrated.

18. The apparatus of claim 17 wherein the early time period is shorter than the later time period.

19. The apparatus of claim 18 wherein the early time period is less than ½ of that of the later time period.

20. The apparatus of claim 16 wherein the predetermined constant falls within the range of 2.5 and 3.
